(19) United States
(12) Patent Application Publication
(10) Pub. No.: US 2026/0180205 A1
(43) Pub. Date: Jun. 25, 2026

(54) ANTENNA RADIATION DEVICE, ANTENNA APPARATUS AND ANTENNA SYSTEM

(71) Applicant: TP-Link Systems Inc., IRVINE, CA (US)

(72) Inventor: Junyu Yang, Chengdu (CN)

(73) Assignee: TP-Link Systems Inc., IRVINE, CA (US)

(21) Appl. No.: 19/001,545

(22) Filed: Dec. 25, 2024

(51) Int. Cl. H01Q 21/24; H01Q 1/48; H01Q 3/32; H01Q 7/00; H01Q 9/16; H01Q 19/10

(52) U.S. Cl. CPC H01Q 21/24; H01Q 3/32; H01Q 7/00; H01Q 9/16; H01Q 19/10; H01Q 1/48

(57) ABSTRACT

Aspects of the present disclosure relate to an antenna radiation device comprising a loop antenna, a dipole antenna, a first switch and a second switch. A first end of the loop antenna is connected to a first power feeding point, and a second end of the loop antenna is connected to a Ground. The dipole antenna includes a first radiation branch and a second radiation branch. The first radiation branch is connected to a first side of the loop antenna via the first switch, the second radiation branch is connected to a second side of the loop antenna via the second switch, and the first side and the second side are symmetrical about a longitudinal axis of the loop antenna. The present disclosure also relates to an antenna apparatus and an antenna system having such an antenna radiation device.

### TECHNICAL FIELD

The present disclosure relates to an antenna radiation device, an antenna apparatus and an antenna system having such an antenna radiation device.

### BACKGROUND

With development of wireless communication technology, reconfigurable antennas are increasingly used based on their variable polarization and radiation pattern. Reconfigurable antennas can be structured in many different ways, and the antenna structure should meet the specific requirements of the user based on the actual application scenario.

For an AP (wireless access point) antenna, it needs to have different polarizations, different radiation ranges, and different radiation patterns according to different scenarios and installation. However, the AP antenna in the existing technology is not reconfigurable, and it cannot meet the different requirements of different scenarios.

### SUMMARY

The present disclosure provides an antenna radiation device. The antenna radiation device is of a planar structure, which has the advantages of low manufacturing cost and small size. In addition, the antenna radiation device can be switched between horizontal and vertical polarization. The present disclosure also provides an antenna apparatus having the antenna radiation device, which can switch the radiation pattern and the switch between the horizontal and the vertical polarization, and can operate in the frequency band of 2˜7 GHZ, and can be applied to a variety of communication systems, such as WiFi, Bluetooth, and so on. The antenna device according to the present disclosure can be designed as an AP antenna, which has variable radiation patterns and can be adapted to different scenarios.

The present disclosure provides an antenna radiation device, the antenna radiation device comprising: a loop antenna, a first end of the loop antenna being connected to a first power feeding point, a second end of the loop antenna being connected to a Ground; a dipole antenna, the dipole antenna comprising a first radiation branch and a second radiation branch; and a first switch and a second switch; wherein the first radiation branch is connected to a first side of the loop antenna through the first switch connected to a first side of the loop antenna, and the second radiation branch is connected to a second side of the loop antenna via the second switch, the first side and the second side are symmetrical about a longitudinal axis of the loop antenna.

In an embodiment according to the present disclosure, the loop antenna is constructed as an electrical mini-loop antenna.

In an embodiment according to the present disclosure, the electrical mini-loop antenna has a length of less than 0.3 wavelengths.

In an embodiment according to the present disclosure, the folded section of the loop antenna between the first radiation branch and the second radiation branch acts as a Balun to ensure a phase difference of 180° between the first radiation branch and the second radiation branch.

In an embodiment according to the present disclosure, the loop antenna is constructed as a square loop antenna, a first branch of the square loop antenna having an opening and forming the first end and the second end, the first end being connected to the first power feeding point by a first feed line and the second end being connected to the Ground by a second feed line; a third branch of the square loop antenna is opposite the opening; a second branch and a fourth branch of the square loop antenna are opposite each other and connected to the first branch; and wherein the first radiation branch is connected to the middle of the second branch through the first switch and the second radiation branch is connected to the middle of the fourth branch through the second switch.

In an embodiment according to the present disclosure, the sum of the lengths of the first radiation branch and the second radiation branch is 0.5 wavelengths.

In an embodiment according to the present disclosure, in response to the switching on of the first switch and the second switch, the antenna radiation device operates in a dipole antenna mode; and in response to the switching off of the first switch and the second switch, the antenna radiation device operates in a loop antenna mode.

In an embodiment according to the present disclosure, the first switch is constructed as a first diode and the second switch is constructed as a second diode.

In an embodiment according to the present disclosure, the anode of the first diode is connected to the first radiation branch and the anode of the second diode is connected to the second radiation branch.

The present disclosure also provides an antenna apparatus, the antenna apparatus comprising an antenna radiation device according to the above embodiments of the present disclosure and a reflective plate, wherein the antenna radiation device is constructed as a planar structure and forms a first plane, the reflective plate forms a second plane, the first plane is perpendicular to the second plane.

The present disclosure also provides an antenna system, the antenna system comprising an antenna radiation device according to the above embodiment of the present disclosure and a control circuit; wherein the control circuit comprises an isolation inductor and a control unit; wherein the first switch is constructed as a first diode, the second switch is constructed as a second diode, the anode of the first diode is coupled with the first radiation branch, and the anode of the second anode of the diode is connected to the second radiation branch; wherein the first radiation branch and the second radiation branch are respectively connected to voltage level inputs through the isolation inductors, and wherein the control unit is configured to control the voltage level inputs to output a high voltage level or a low voltage level.

In an embodiment according to the present disclosure, the antenna system further comprises an indicator light, the indicator light is connected to the voltage level input.

### DESCRIPTION OF DRAWINGS

In order to more clearly illustrate the technical solutions of the embodiments of the present disclosure, the accompanying drawings used in the description of the embodiments will be briefly described below. Obviously, the accompanying drawings in the following description are only some exemplary embodiments of the present disclosure, and for a person of ordinary skill in the art, other embodiments may be obtained based on these embodiments without creative labor.

FIG. 1 schematically illustrates the structure of an antenna radiation device according to an embodiment of the present disclosure;

FIG. 2 schematically illustrates a structure of an antenna apparatus according to an embodiment of the present disclosure;

FIG. 3 schematically illustrates a two-dimensional radiation pattern of an antenna apparatus according to an embodiment of the present disclosure operating in a dipole antenna mode;

FIG. 4 schematically illustrates a two-dimensional radiation pattern of an antenna apparatus according to an embodiment of the present disclosure operating in a loop antenna mode;

FIG. 5 illustrates a radiation pattern of an orientation diagram with maximum gain for an antenna apparatus according to an embodiment of the present disclosure in dipole antenna mode and loop antenna mode;

FIG. 6 illustrates a radiation pattern of an orientation diagram tilted 30° from the horizontal of an antenna apparatus according to an embodiment of the present disclosure in a dipole antenna mode and a loop antenna mode;

FIG. 7 illustrates a radiation pattern of an orientation diagram tilted 60° from the horizontal of an antenna apparatus according to an embodiment of the present disclosure in a dipole antenna mode and a loop antenna mode;

FIG. 8 illustrates a plot of reflection coefficient versus frequency for an antenna apparatus according to an embodiment of the present disclosure in a dipole antenna mode and a loop antenna mode; and

FIG. 9 schematically illustrates a circuit diagram for an antenna system according to an embodiment of the present disclosure.

### DETAILED DESCRIPTION

In order to make the objects, technical solutions and advantages of the present disclosure more apparent, example embodiments according to the present disclosure will be described in detail below with reference to the accompanying drawings. Obviously, the described embodiments are only a part of the embodiments of the present disclosure and not all of the embodiments of the present disclosure, and it should be understood that the present disclosure is not limited by the example embodiments described herein.

In this specification and the accompanying drawings, substantially the same or similar method steps and elements are represented by the same or similar drawing symbols, and repetitive descriptions of these method steps and elements will be omitted. Also, in the description of the present disclosure, the terms “first”, “second”, and the like are used only to differentiate descriptions and are not to be understood as indicating or implying relative importance or ordering. In an embodiment of the present disclosure, unless expressly stated otherwise, “connected” does not mean that there must be a “direct connection” or “direct contact”, but only an electrical connection is required.

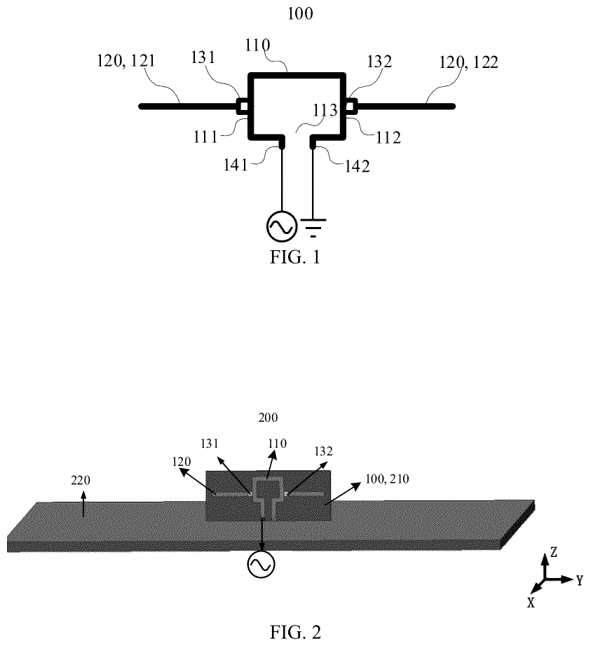

FIG. 1 schematically illustrates a structure of an antenna radiation device 100 according to an embodiment of the present disclosure. The antenna radiation device 100 includes a loop antenna 110, a dipole antenna 120, a first switch 131, and a second switch 132. The loop antenna 110 is constructed as an unenclosed loop and thus has a first end 141 and a second end 142 at an opening 113 thereof. The first end 141 of the loop antenna 110 is connected to a first power feeding point. In the embodiment shown in FIG. 1, the first power feeding point is exemplarily designed as an RF signal source. The second end 142 of the loop antenna 110 is connected to a Ground.

The dipole antenna 120 includes a first radiation branch 121 and a second radiation branch 122. In the embodiment shown in FIG. 1, the first radiation branch 121 is connected to a first side 111 of the loop antenna 110 via a first switch 131 and the second radiation branch 122 is connected to a second side 112 of the loop antenna 110 via a second switch 132.

In the present disclosure, the loop antenna 110 can have any shape. The first side 111 and the second side 112 of the loop antenna 110 are symmetrical about a longitudinal axis of the loop antenna 110, and the longitudinal axis extends along the opening direction of the loop antenna 110.

In an embodiment according to the present disclosure, the first switch 131 and the second switch 132 can be constructed as a diode or an RF switch.

In an embodiment according to the present disclosure, the loop antenna 110 can in particular be constructed as a square loop antenna, as shown in FIG. 1. For the square loop antenna 110, a first branch thereof has an opening 113 and forms the first end 141 and the second end 142. The first end 141 can be connected, e.g., via a first feed line to the first power feeding point (the RF signal source in FIG. 1), and the second end 142 can be connected, e.g., via a second feed line to the Ground. A third branch of the square loop antenna 110 is opposite the opening 113. The second branch (corresponding to the first side 111) and the fourth branch (corresponding to the second side 112) of the square loop antenna 110 are opposite each other and connected to the first branch. For the loop antenna 110 constructed as a square, the first radiation branch 121 is connected to the middle of the second branch via a first switch 131 and the second radiation branch 122 is connected to the middle of the fourth branch via a second switch 132.

For a dipole antenna based on the prior art, the power feeding phases of the two radiation branches differ by 180°. In the present disclosure, when the first switch 131 and the second switch 132 are switched on, the first radiation branch 121 is connected to the second radiation branch 122 via a bent path on the loop antenna 110. The bent path on the loop antenna 110, and in particular the folded section thereof, serves as a “Balun” for ensuring a phase difference of 180° between the first radiation branch 121 and the second radiation branch 122. In the case where the loop antenna 110 is combined with a dipole antenna 120, it is a highly preferred solution that the section on the loop antenna 110 between the first radiation branch 121 and the second radiation branch 122 is designed as a “Balun”. This solution fully utilizes the pre-existing structure of the loop antenna 110 and provides a power-feeding balance to the dipole antenna 120, improving the matching between the two radiation branches of the dipole antenna.

In an embodiment according to the present disclosure, the loop antenna 110 can in particular be constructed as an electrically small loop antenna. An electrically small loop antenna is in particular a loop antenna in which the length of the conductor wound into a loop is much smaller than the wavelength of the radio signal. In an embodiment according to the present disclosure, the length of the electrically small loop antenna can, e.g., be less than 0.3 wavelengths.

In an embodiment according to the present disclosure, the length of the dipole antenna 120, i.e., the sum of the lengths of the first radiation branch 121 and the second radiation branch 122, can preferably be 0.5 wavelengths. In other words, the dipole antenna 120 can preferably be constructed as a half-wave oscillator antenna which has a nearly optimal radiation efficiency.

FIG. 2 illustrates an antenna apparatus 200 formed based on an antenna radiation device. The antenna apparatus 200 includes an antenna radiation device 100 and a reflective plate 220 according to an embodiment of the present disclosure. The antenna radiation device 100 is constructed as a planar structure and forms a first plane 210. The reflective plate 220 forms a second plane 220. The first plane 210 is perpendicular to the second plane 220. In an embodiment according to the present disclosure, the antenna radiation device 100 can, e.g., be arranged on an FR-4 substrate. The reflective plate 220 can, e.g., be arranged on an FR-4 substrate.

The radiation pattern of the radiated field of the antenna radiation device 100 as well as the polarization component depends on the distance from the antenna radiation device 100 to the reflective plate 220. In an embodiment according to the present disclosure, the distance from the antenna radiation device 100 to the reflective plate 220 can preferably be 0.1 wavelength, and the distance from the lowest point of the antenna radiation device 100 to the reflective plate 220 can preferably be, e.g., 0.1 wavelength, and the distance from the highest point of the antenna radiation device 100 to the reflective plate 220 can preferably be, e.g., less than 0.15 wavelength. The antenna apparatus 200 according to the present disclosure therefore has a small size.

The antenna radiation device 100 according to the present disclosure and the antenna apparatus 200 according to the present disclosure can operate as a dipole antenna in response to the switching on of the first switch 131 and the second switch 132, and can operate as a loop antenna in response to the switching off of the first switch 131 and the second switch 132.

In the absence of reflector 220, the E-plane of the dipole antenna pattern is an ‘inverted 8’ shape, and the H-plane is an ‘O’ shape; the E-plane of the small loop antenna pattern is an ‘O’ shape, and the H-plane is an ‘inverted 8’ shape. The radiation patterns of the two antennas complement each other well.

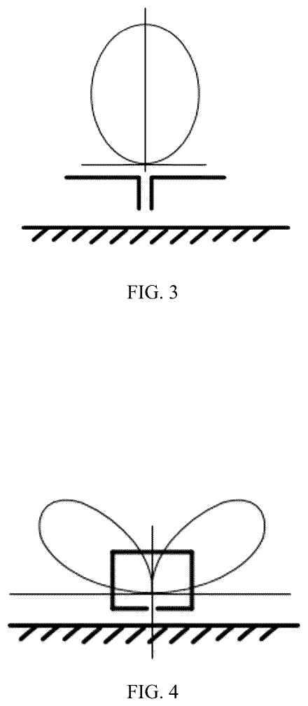

With the reflective plate 220 arranged, the radiation pattern of the dipole antenna forms a large inclination by reflection. FIG. 3 schematically illustrates a two-dimensional radiation pattern of the antenna apparatus 200 according to an embodiment of the present disclosure operating in a dipole antenna mode. This radiation pattern is approximately directional radiation with horizontal polarization.

With the reflective plate 220 arranged, the radiation pattern of the loop antenna forms a small inclination by reflection. FIG. 4 schematically illustrates a two-dimensional radiation pattern of the antenna apparatus 200 according to an embodiment of the present disclosure operating in a loop antenna. This radiation pattern provides horizontal omnidirectional radiation with vertical polarization.

The antenna apparatus 200 according to the present disclosure can switch between a dipole antenna mode and a loop antenna mode, combining the radiation characteristics of dipole antennas and loop antennas. The radiation patterns of the dipole antenna and the loop antenna have opposite polarizations, which complement each other well and thus cancel out the radiation zeros of each radiation pattern, resulting in good omnidirectional coverage.

The antenna device 200 according to the present disclosure can in particular be used as an AP antenna.

The AP antenna according to the present disclosure may be ceiling-mounted. The AP antenna may change or switch the inclination of the radiation as well as the intensity of the radiation according to a specific scenario. For example, an AP antenna in dipole antenna mode has a large inclination angle, a small radius of radiation, but a large radiation strength, which can meet the demand for strong radiation in a small area and has the advantage of anti-interference when deployed in a high density. An AP antenna in loop antenna mode has a small radiation strength, but a small inclination angle and a large radius of radiation, and thus can cover a larger area.

The AP antennas according to the present disclosure can also be wall-mounted. Ceiling-mounted AP antennas in prior art are not suitable for wall mounting because wall mounting results in radiation upwardly and downwardly dispersed and horizontally polarized. The AP antenna according to the present disclosure can be switched to dipole antenna mode when mounted against a wall, thereby achieving the desired horizontal omnidirectional radiation and vertical polarization.

The AP antenna according to the present disclosure balances wide-area coverage with high-density deployment scenarios, can be ceiling-mounted and wall-mounted, and has a simple structure, small size, and low cost.

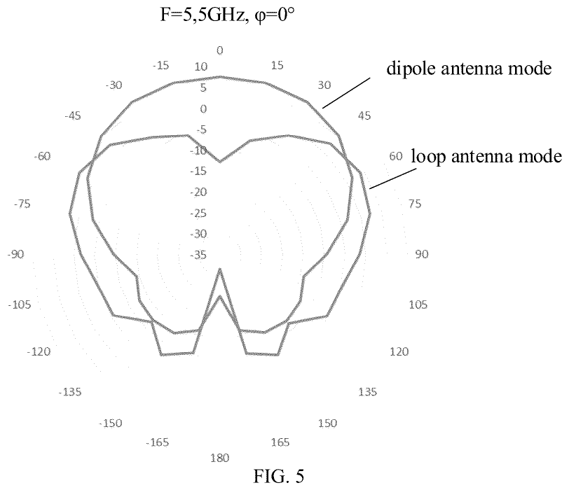

FIG. 5 to FIG. 8 illustrate radiation patterns as well as reflection coefficient curves for the antenna apparatus 200 according to the present disclosure. FIG. 5 to FIG. 8 illustrate the characteristics of the antenna apparatus 200 according to the present disclosure under the 5G frequency band (5.5 GHZ). The antenna apparatus 200 according to the present disclosure can be applied to a variety of communication systems such as WiFi, Bluetooth, etc., and can operate under the frequency band of 2 to 7 GHZ, and has the same characteristics as shown in FIG. 5 to FIG. 8.

FIG. 5 illustrates a radiation pattern of an orientation diagram with maximum gain for an antenna apparatus according to an embodiment of the present disclosure in dipole antenna mode and loop antenna mode. As shown in FIG. 5, in the loop antenna mode, the antenna apparatus 200 provides omnidirectional radiation with a small inclination, a maximum gain of 4 dBi, and a maximum radiation inclination is approximately 25° tilted from the horizontal plane. In the dipole antenna mode, the antenna apparatus 200 exhibits directional radiation with a maximum gain of 7.5 dBi, a beamwidth of about 100°, and a maximum radiation inclination covering a range from 35° upwardly tilted from the horizontal plane to 90° downwardly tilted from the horizontal plane. In the dipole antenna mode and the loop antenna mode, the antenna apparatus 200 has a very significant change in the radiation inclination angle and is superimposed to cover almost the entire hemisphere.

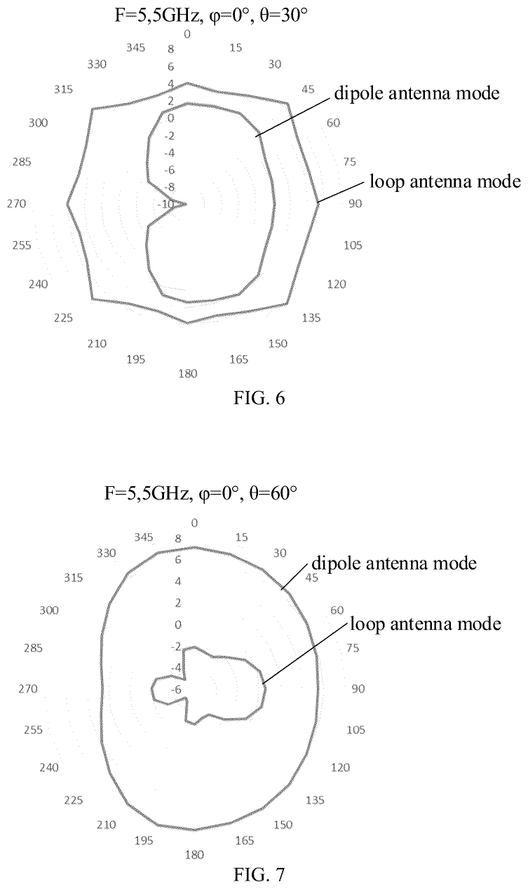

FIG. 6 illustrates a radiation pattern of an orientation diagram tilted 30° (θ=30°) from the horizontal of an antenna apparatus according to an embodiment of the present disclosure in a dipole antenna mode and a loop antenna mode. FIG. 7 illustrates a radiation pattern of an orientation diagram tilted 60° (θ=30°) from the horizontal of an antenna apparatus according to an embodiment of the present disclosure in a dipole antenna mode and a loop antenna mode. As shown in FIG. 6 and FIG. 7, in the dipole antenna mode, the antenna apparatus 200 has good omnidirectional radiation characteristics for a large inclination angle, such as in the range of θ=45° to θ=90°. In the loop antenna mode, the antenna apparatus 200 has good omnidirectional radiation characteristics for low inclination angles, such as in the range of θ=20° to θ=45°.

The antenna apparatus 200 according to the present disclosure can be switched between a dipole antenna mode and a loop antenna mode by simultaneous switching on and off of the first switch 131 and the second switch 132, which allows reconstructing the radiation pattern, in particular the inclination angle with the radiation pattern. The dipole antenna mode and the loop antenna mode superimposed on each other can radiate almost the entire hemisphere.

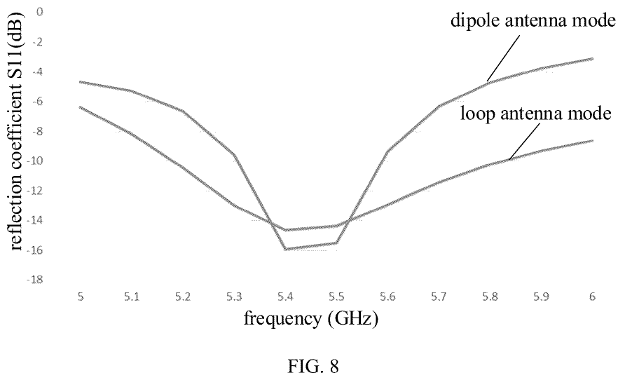

FIG. 8 illustrates a plot of reflection coefficient versus frequency for an antenna apparatus 200 in a dipole antenna mode and a loop antenna mode according to an embodiment of the present disclosure. The reflection coefficient represents the ratio of the signal power reflected back to the source to the signal power injected from the source, and the reflection coefficient RL=10 log (reflected power/incident power) in −dB. The value of the reflection coefficient ranges from 0 dB to negative infinity, and a smaller reflection coefficient indicates a better match of the antenna apparatus 200. In mobile communication systems, the reflection coefficient is generally required to be less than −14 dB. As can be seen in FIG. 8, the reflection coefficients of the antenna apparatus 200 in the dipole antenna mode and the loop antenna mode are both less than −14 dB under 5G band (5.5 GHZ), which satisfy the basic design requirements of the antenna.

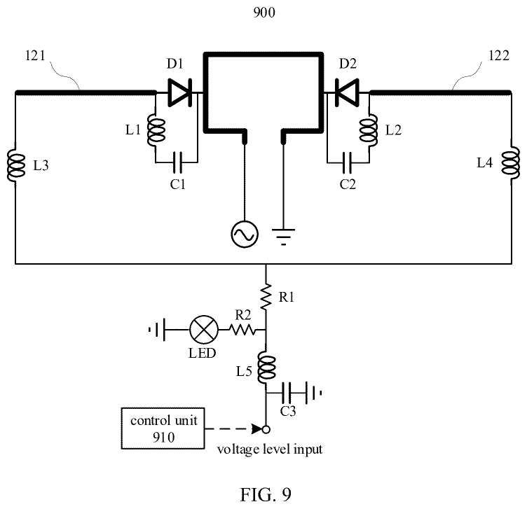

FIG. 9 schematically illustrates a circuit diagram for an antenna system 900 according to an embodiment of the present disclosure. The antenna system 900 includes an antenna radiation device 100 according to the above embodiment of the present disclosure or an antenna apparatus 200 according to the above embodiment of the present disclosure and control circuit, which will be described in detail later.

In the antenna system 900 according to an embodiment of the present disclosure, the first switch is constructed as a first diode D1 and the second switch is constructed as a second diode D2, and the anode of the first diode D1 is connected to one end of the first radiation branch 121 and the anode of the second diode D2 is connected to one end of the second radiation branch 122. The other end of the first radiation branch 121 is connected to the voltage level input via the isolation inductor L3, and the other end of the second radiation branch 122 is connected to the voltage level input via the isolation inductor L4. The control unit 910 is configured to control the voltage level input to output a high voltage level or a low voltage level.

In this embodiment, the first end of the antenna radiation device 100 is connected to an RF signal source and the first end of the antenna radiation device 100 is connected to a ground potential. Since the antenna radiation device 100 is at a lower potential, only a high or low voltage level needs to be applied to the anodes of the first diode D1 and the second diode D2 to switch the first diode D1 and the second diode D2 on and off.

With the isolation inductors L3, L4, the AC signals fed into the antenna radiation device 100 are blocked and are not transmitted to the control circuit, but the high or low voltage levels at the voltage level inputs are not blocked, and the switching on and off of the first diode D1 and the second diode D2 can thus be controlled.

In an embodiment according to the present disclosure, the control circuit of the antenna system 900 can further comprise a matching inductor L1 and a matching capacitor C1 connected in parallel to the first diode D1; and a matching inductor L2 and a matching capacitor C2 connected in parallel to the second diode D2.

In an embodiment according to the present disclosure, the control circuit of the antenna system 900 can further comprise: an indicator LED, which can in particular be constructed as a light-emitting diode. The indicator LED is connected to a voltage level input. When the voltage level input is at a high level, the first diode D1 and the second diode D2 are switched on, the indicator LED is illuminated and thus can indicate the dipole antenna mode; when the voltage level input is at a low level, the first diode D1 and the second diode D2 are switched off, the indicator LED is extinguished and thus can indicate the loop antenna mode.

In an embodiment according to the present disclosure, the control circuit of the antenna system 900 can further comprise an additional isolation inductor L5, which is connected between the voltage level input and the indicator LED; and a filter capacitor C3, which connects the voltage level input to a ground potential for eliminating high frequency noise.

In additional embodiments according to the present disclosure, a voltage dividing resistor R1 can also be arranged between the isolation inductor L5 and the isolation inductor L3 and the isolation inductor L3, and a voltage dividing resistor R2 can be arranged between the isolation inductor L5 and the indicator LED.

The block diagrams of the circuits, units, devices, apparatuses, equipment, and systems involved in this disclosure are intended to be exemplary only and do not purport to require or imply that they must be connected, arranged, configured in the manner illustrated in the block diagrams. As those skilled in the art will recognize, the circuits, units, devices, apparatuses, equipment, and systems can be connected, arranged, and configured in any manner as long as they are capable of achieving the desired purpose. The circuits, units, devices, appliances involved in this disclosure can be implemented in any suitable manner, such as by using special purpose integrated circuits, field programmable gate arrays (FPGAs), etc., or by using a general purpose processor in combination with a program.

It should be understood by those skilled in the art that the above specific embodiments are only examples and not limitations, and various modifications, combinations, partial combinations, and substitutions of the embodiments of the present disclosure can be made according to design needs and other factors, as long as they are within the scope of the appended claims or their equivalents, which fall within the scope of the rights that the present disclosure is intended to protect.

1. An antenna radiation device comprising:
a loop antenna, a first end of the loop antenna being connected to a first power feeding point, a second end of the loop antenna being connected to a ground, wherein the loop antenna is constructed as a rectangular loop antenna;
a dipole antenna, the dipole antenna comprising a first radiation branch and a second radiation branch; and
a first switch and a second switch, wherein the first switch and the second switch are configured as active, controllable switching elements;
wherein the first radiation branch is connected to a first side of the rectangular loop antenna via the first switch, and the second radiation branch is connected to a second side of the rectangular loop antenna via the second switch, the first side and the second side are symmetrical about the longitudinal axis of the rectangular loop antenna; and
a radiation characteristic of the antenna radiation device depends on switching on or off of the first switch and the second switch.

2. The antenna radiation device according to claim 1, wherein the loop antenna is constructed as an electrical mini-loop antenna.

3. The antenna radiation device according to claim 2, wherein the length of the electrical mini-loop antenna is less than 0.3 wavelengths.

4. The antenna radiation device according to claim 1, wherein a folded section of the loop antenna between the first radiation branch and the second radiation branch acts as a Balun to ensure a phase difference of 180° between the first radiation branch and the second radiation branch.

5. The antenna radiation device according to claim 1, wherein a first branch of the rectangular loop antenna having an opening and forming the first end and the second end, the first end being connected to the first power feeding point by a first feed line and the second end being connected to the ground by a second feed line;
a third branch of the rectangular loop antenna is opposite the opening;
a second branch and a fourth branch of the rectangular loop antenna are opposite each other and connected to the first branch; and
wherein the first radiation branch is connected to the middle of the second branch through the first switch and the second radiation branch is connected to the middle of the fourth branch through the second switch.

6. The antenna radiation device according to claim 1, wherein the sum of the lengths of the first radiation branch and the second radiation branch is 0.5 wavelengths.

7. The antenna radiation device according to claim 1, wherein, in response to the switching on of the first switch and the second switch, the antenna radiation device operates in a dipole antenna mode; and
in response to the switching off of the first switch and the second switch, the antenna radiation device operates in a loop antenna mode.

8. The antenna radiation device according to claim 1, wherein the first switch is constructed as a first diode and the second switch is constructed as a second diode.

9. An antenna radiation device according to claim 8, wherein the anode of the first diode is connected to the first radiation branch and the anode of the second diode is connected to the second radiation branch.

10. An antenna apparatus comprising:
the antenna radiation device according to claim 1 and a reflective plate,
wherein the antenna radiation device is constructed as a planar structure and forms a first plane, the reflective plate forms a second plane, the first plane is perpendicular to the second plane.

11. An antenna system comprising:
the antenna radiation device according to claim 9 and a control circuit;
wherein the control circuit comprises an isolation inductor and a control unit;
wherein the first radiation branch and the second radiation branch are respectively connected to a voltage level input via the isolating inductor, and the control unit is configured to control the voltage level input to output a high voltage level or a low voltage level.

12. The antenna system according to claim 11, further comprising:
an indicator light, which is connected to the voltage level input.
